(19) United States
(12) Patent Application Publication
(10) Pub. No.: US 2026/0288476 A1
(43) Pub. Date: Sep. 24, 2026

(54) ELECTRONIC DEVICE AND OPERATION METHOD THEREOF

(71) Applicant: ASPEED Technology Inc., Hsinchu City (TW)

(72) Inventors: Po-Wei Huang, Hsinchu City (TW); Chih-Chiang Mao, Hsinchu City (TW)

(73) Assignee: ASPEED Technology Inc., Hsinchu City (TW)

(21) Appl. No.: 19/174,863

(22) Filed: Apr. 9, 2025

(30) Foreign Application Priority Data
Mar. 20, 2025 (TW) 114110437

(51) Int. Cl. G06F 9/4401; G06F 1/28

(52) U.S. Cl. CPC G06F 9/4401; G06F 1/28

(57) ABSTRACT

An electronic device and an operation method thereof are provided. The electronic device includes a memory, a management control circuit, and an input/output expander. The memory is configured to store a boot code and a power management code. The management control circuit reads the boot code and the power management code from the memory. The management control circuit performs a booting operation according to the boot code. The input/output expander receives the power management code from the management control circuit. The input/output expander includes a power controller, and the power controller generates multiple power control signals according to the management control circuit.

### CROSS-REFERENCE TO RELATED APPLICATION

This application claims the priority benefit of Taiwan application serial no. 114110437, filed on March 20, 2025. The entirety of the above-mentioned patent application is hereby incorporated by reference herein and made a part of this specification.

### BACKGROUND

### Technical Field

The disclosure relates to an electronic device and an operation method thereof, and in particular to an electronic device and an operation method which may reduce hardware cost.

### Related Art

In a conventional electronic device, a baseboard management controller circuit communicates with a field effect programmable logic gate array through a serial general-purpose input/output (SGPIO) interface. The field effect programmable logic gate array may be configured to generate power control signals for peripheral circuits of the electronic device. However, in current applications, the electronic device needs to separately dispose different memories corresponding to the management control circuit and the field effect programmable logic gate array respectively. These two memories are configured to store the boot code of the management control circuit and the power management code of the field effect programmable logic gate array respectively. That is, in the conventional electronic device, to effectively operate the management control circuit and the field effect programmable logic gate array, a relatively large quantity of memories need to be disposed. Moreover, corresponding to the configuration of the memories, different memory control circuits also need to be disposed in the management control circuit and the field effect programmable logic gate array respectively, increasing the hardware cost.

### SUMMARY

The disclosure provides an electronic device and an operation method thereof, which may reduce a usage requirement of a memory and reduce cost required for the electronic device.

An electronic device of the disclosure includes a memory, a management control circuit, and an input/output expander. The memory is configured to store a boot code and a power management code. The management control circuit is coupled to the memory, reads the boot code and the power management code from the memory, and performs a boot operation according to the boot code. The input/output expander is coupled to the management control circuit, and receives the power management code from the management control circuit. The input/output expander includes a power controller, and the power controller generates multiple power control signals according to the power management code.

An operation method of an electronic device of the disclosure includes: making the memory to store a boot code and a power management code; making the management control circuit to read the boot code and the power management code from the memory; making the management control circuit to perform the boot operation according to the boot code; and making the input/output expander to receive the power management code from the management control circuit, and making the power controller of the input/output expander to generate multiple power control signals according to the power management code.

Based on the above, in the electronic device of the disclosure, the boot code of the management control circuit and the power management code needed by the power controller of the input/output expander may be stored in the same memory. The management control circuit performs a read operation on the memory to obtain the boot code and the power management code. The management control circuit may perform the boot operation according to the obtained boot code, and send the obtained power management code to the input/output expander. Furthermore, the power controller of the input/output expander may generate the power control signals for multiple peripheral circuits according to the power management code.

### BRIEF DESCRIPTION OF THE DRAWINGS

FIG. 1 illustrates a schematic diagram of an electronic device according to an embodiment of the disclosure.

FIG. 2 illustrates a schematic diagram of an electronic device according to another embodiment of the disclosure.

FIG. 3 illustrates a flowchart of an operation method of an electronic device according to an embodiment of the disclosure.

FIG. 4 illustrates a schematic diagram of an electronic device according to another embodiment of the disclosure.

FIG. 5A and FIG. 5B respectively illustrate flowcharts of a security check operation of a security check circuit according to an embodiment of the disclosure.

FIG. 6 illustrates a flowchart of an operation of an electronic device according to an embodiment of the disclosure.

### DESCRIPTION OF THE EMBODIMENTS

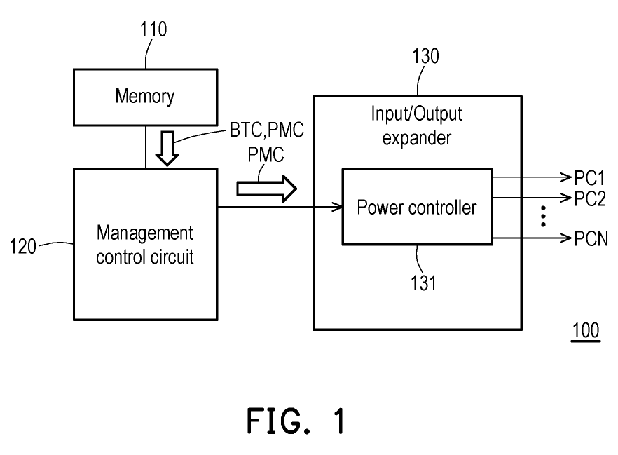

Referring to FIG. 1, FIG. 1 illustrates a schematic diagram of an electronic device according to an embodiment of the disclosure. An electronic device 100 includes a memory 110, a management control circuit 120, and an input/output expander 130. The memory 110 is configured to store a boot code BTC and a power management code PMC. The management control circuit 120 is coupled to the memory 110. The management control circuit 120 is configured to read the boot code BTC and the power management code PMC from the memory 110. The management control circuit 120 may perform a boot operation according to the boot code BTC. Furthermore, the management control circuit 120 may send the power management code PMC to the input/output expander 130.

In this embodiment, the input/output expander 130 includes a power controller 131. The power controller 131 may receive the power management code PMC sent by the management control circuit 120 and generate multiple power control signals PC1 to PCN according to the power management code PMC. The power control signals PC1 to PCN may respectively correspond to multiple peripheral circuits and are respectively configured to control the time sequence of the electronic device 100 providing power voltages to the respectively corresponding peripheral circuits.

In detail, in a boot process of the electronic device 100, after the electronic device 100 performs power on, the management control circuit 120 may read the boot code BTC and the power management code PMC from the memory 110. Afterwards, the management control circuit 120 may start a boot program and make a central processing unit thereof perform the boot operation according to the boot code BTC. Furthermore, the management control circuit 120 may send the power management code PMC to the power controller 131 of the input/output expander 130. The power controller 131 may determine the power-on sequence of each peripheral circuit according to the power management code PMC and generate the power control signals PC1 to PCN accordingly.

In this embodiment, the management control circuit 120 may be a baseboard management controller (BMC) circuit. The memory 110 may be any form of memory, such as flash memory. In the memory 110, the boot code BTC and the power management code PMC may be pre-stored in a predetermined address of the memory 110. The management control circuit 120 may obtain the boot code BTC and the power management code PMC through reading the predetermined address of the memory 110 in the boot process.

It is worth noting that, in this embodiment, through storing the boot code BTC and the power management code PMC in the same memory 110, the electronic device 100 does not need to additionally dispose another memory corresponding to the input/output expander 130 to store the power management code PMC. In addition to reducing the usage quantity of the memory, there is also no need to dispose control circuits related to a memory access operation in the input/output expander 130. In this way, the complexity of the circuit design of the input/output expander 130 may be simplified, and the cost of the electronic device 100 may be effectively reduced, enhancing product competitiveness.

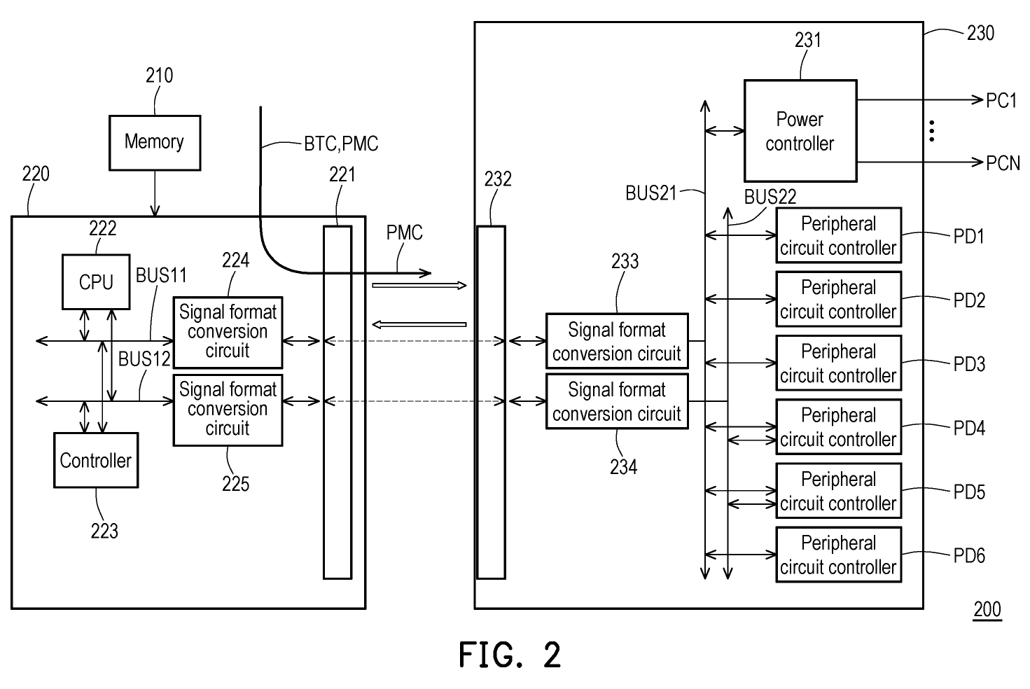

Referring to FIG. 2 below, FIG. 2 illustrates a schematic diagram of an electronic device according to another embodiment of the disclosure. An electronic device 200 includes a memory 210, a management control circuit 220, and an input/output expander 230. The memory 210 is coupled to the management control circuit 220. In this embodiment, the management control circuit 220 includes an interface circuit 221, a central processing unit (CPU) 222, a controller 223, and signal format conversion circuits 224 and 225. The signal format conversion circuits 224 and 225 are coupled to the interface circuit 221 and are respectively coupled to the CPU 222 and the controller 223 through buses BUS11 and BUS12 respectively. The signal format conversion circuits 224 and 225 are used for a format conversion operation of transceived data between the CPU 222, the controller 223, and the signal format conversion circuits 224 and 225. For example, in this embodiment, the interface circuit 221 may be a low voltage differential signal (LVDS) tunneling protocol & interface (LTPI) and may be configured to transmit the transmitted data in the LVDS format. The bus BUS11, for example, may be configured to transmit the transmitted data in an advanced high-performance bus (AHB) signal format, while the bus BUS12, for example, may be configured to transmit the transmitted data in a meter BUS (M-BUS) signal format.

In details of the embodiment, the signal format conversion circuit 224 may receive the received data from the interface circuit 221 and convert the received data in the LVDS format to the received data in the AHB signal format and transmit the received data in the AHB signal format to the CPU 222 through the bus BUS11. Similarly, the signal format conversion circuit 225 may receive the received data from the interface circuit 221 and convert the received data from the LVDS format to the M-BUS signal format and transmit the received data in the M-BUS signal format to the controller 223 through the bus BUS12.

In addition, the signal format conversion circuits 224 and 225 may respectively receive different transmitted data from the CPU 222 and the controller 223, through the buses BUS11 and BUS12. The signal format conversion circuits 224 and 225 may respectively convert the received transmitted data to the LVDS format and transmit the transmitted data in the LVDS format to the interface circuit 221, which then transmits the transmitted data in the LVDS format out. Here, the controller 223 may be a memory controller.

It is worth noting that, in this embodiment, a number of signal format conversion circuits 224 and 225 of the management control circuit 220 may be one or multiple (two or more). The designer may adjust the number of signal format conversion circuits of the management control circuit according to actual needs, without any particular limitations. The drawing in FIG. 2 is merely an illustrative example and is not used to limit the implementation scope of the disclosure.

In another aspect, the input/output expander 230 includes a power controller 231, an interface circuit 232, signal format conversion circuits 233 and 234, and multiple peripheral circuit controllers PD1 to PD6. The interface circuit 232, like the interface circuit 221, is an interface circuit in the LPTI format, configured to transmit the transmitted data in the LVDS format. The signal format conversion circuits 233 and 234 are coupled to the interface circuit 232. The signal format conversion circuit 233 is coupled to the power controller 231 and the peripheral circuit controllers PD1 to PD6 through the bus BUS21. The signal format conversion circuit 234 may be coupled to the peripheral circuit controllers PD4 and PD5 through the bus BUS22.

The input/output expander 230 is mutually coupled with the interface circuit 221 of the management control circuit 220 through the interface circuit 232. Thereby, a communication operation may be performed between the input/output expander 230 and the management control circuit 220 through the interface circuits 232 and 221.

The signal format conversion circuit 233 is configured to convert the received data in the LVDS format obtained by the interface circuit 232 from the interface circuit 221 to the received data in the AHB signal format and then transmit the received data in the AHB signal format to at least one of the power controllers 231 and the peripheral circuit controllers PD1 to PD6 through the bus BUS21. Similarly, the signal format conversion circuit 234 is configured to convert the received data in the LVDS format obtained by the interface circuit 232 from the interface circuit 221 to the received data in an instrument bus signal format and transmit the received data in the instrument bus signal format to at least one of the peripheral circuit controllers PD4 and PD5 through the bus BUS22.

In addition, the signal format conversion circuit 233 may receive transmitted data from at least one of the power controller 231 and the peripheral circuit controllers PD1 to PD6. The signal format conversion circuit 234 may receive transmitted data from at least one of the peripheral circuit controllers PD4 and PD5. The signal format conversion circuits 233 and 234 may respectively convert the received transmitted data to the transmitted data in the LVDS format and transmit the transmitted data in the LVDS format to the interface circuit 232, which then transmits the transmitted data in the LVDS format out.

Regarding the operation details of the electronic device 200, the management control circuit 220 may read the boot code BTC and the power management code PMC from the memory 210. The CPU 222 of the management control circuit 220 may perform the boot operation according to the boot code BTC. Furthermore, the management control circuit 220 may convert the power management code PMC to the power management code PMC in the LVDS format through one of the signal format conversion circuits 224 and 225 and send the power management code PMC in the LVDS format through the interface circuit 221. On the other hand, the input/output expander 230 may receive the power management code PMC in the LVDS format through the interface circuit 232. Afterwards, through the signal format conversion circuit 223, the power management code PMC in the LVDS format may be converted to the power management code PMC in the AHB signal format and then transmitted to the power controller 231 through the bus BUS21. Thereby, the power controller 231 may generate the power control signals PC1 to PCN according to the received power management code PMC.

Incidentally, in this embodiment, the peripheral circuit controllers PD1 to PD6 respectively correspond to the peripheral circuits and are configured to generate multiple control signals to perform the control operation on the respectively corresponding peripheral circuits. In an embodiment of the disclosure, the peripheral circuits respectively corresponding to the peripheral circuit controllers PD1 to PD6 are, for example, analog-to-digital conversion circuits, pulse modulation signal generation circuits, rotation speed detection circuits, improved inter integrated circuits (I³C), inter integrated circuits (I²C), and joint test action group (JTAG) signal generation circuits.

Of course, the types and number of the peripheral circuits mentioned above are only examples for illustration and are not used to limit the implementation scope of the disclosure. Those having ordinary skill in the art may dispose the required peripheral circuits according to actual needs, and correspondingly adjust the number of peripheral circuit controllers, without any specific limitation.

It is worth noting that, in this embodiment, the signal format conversion circuits 224, 225, 233, and 234 may be digital circuits, and may apply a hardware architecture of signal format converters well-known to those having ordinary skill in the art to implement, without any specific limitation. In addition, the power controller 231 may also be implemented by the digital circuits. For example, the power controller 231 may apply a field-programmable gate array (FPGA) to implement. Alternatively, in other embodiments of the disclosure, the power controller 231 may also apply a microcontroller (MCU) generally well-known to those having ordinary skill in the art to implement, without any specific limitation.

In the embodiment of the disclosure, the electronic device 200 does not need to additionally dispose a memory corresponding to the input/output expander 230 to provide the power management code PMC, which may achieve a memory-less design concept. Moreover, when the power controller 231 is implemented by applying the field-programmable gate array, the input/output expander 230 may achieve a memory-less and CPU-less design concept.

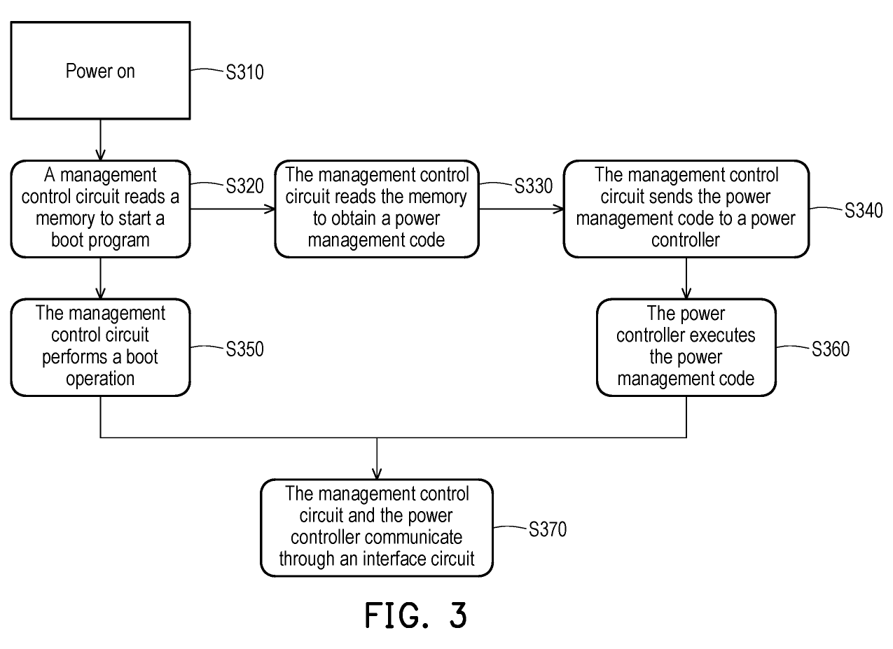

Referring to FIG. 2 and FIG. 3 together, FIG. 3 illustrates a flowchart of an operation method of an electronic device according to an embodiment of the disclosure. In step S310, the electronic device 200 performs power on. In step S320, the management control circuit 220 of the electronic device 200 reads the memory 210 to obtain the boot code BTC, thereby starting a boot program, and executing step S350. In step S330, the management control circuit 220 reads the memory 210 to obtain the power management code PMC. In step S350, the management control circuit 220 performs the boot operation according to the boot code BTC. In step S340, the management control circuit 220 sends the obtained power management code PMC to the power controller 231 of the input/output expander 230. In step S360, the power controller 231 executes the power management code PMC and generates the power control signals PC1 to PCN accordingly.

In step S370, after the boot operation of the management control circuit 220 and the generation operation of the power control signals PC1 to PCN by the power controller 231 are completed, the management control circuit 220 and the power controller 231 may continuously communicate through the interface circuits 221 and 232 between the management control circuit 220 and the input/output expander 230.

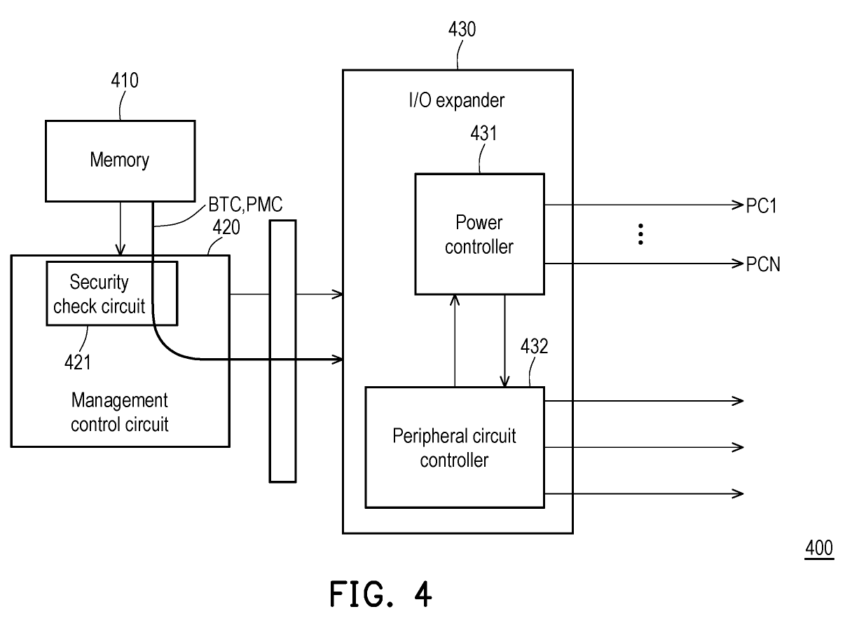

Referring to FIG. 4, FIG. 4 illustrates a schematic diagram of an electronic device according to another embodiment of the disclosure. An electronic device 400 includes a memory 410, a management control circuit 420, and an input/output expander 430. The input/output expander 430 includes a power controller 431 and multiple peripheral circuit controllers 432.

In the embodiment of the disclosure, the relevant implementation details of the memory 410 and the input/output expander 430 are the same as the aforementioned embodiments and are not repeated here. Different from the aforementioned embodiments, the management control circuit 420 includes a security check circuit 421. The security check circuit 421 is coupled to a path where the management control circuit 420 receives the boot code BTC and the power management code PMC. The security check circuit 421 is configured to perform a security verification operation on the boot code BTC and the power management code PMC, to prevent malicious persons from executing a malicious boot code BTC and/or power management code PMC in the memory 410 to damage the normal operation of the electronic device 400.

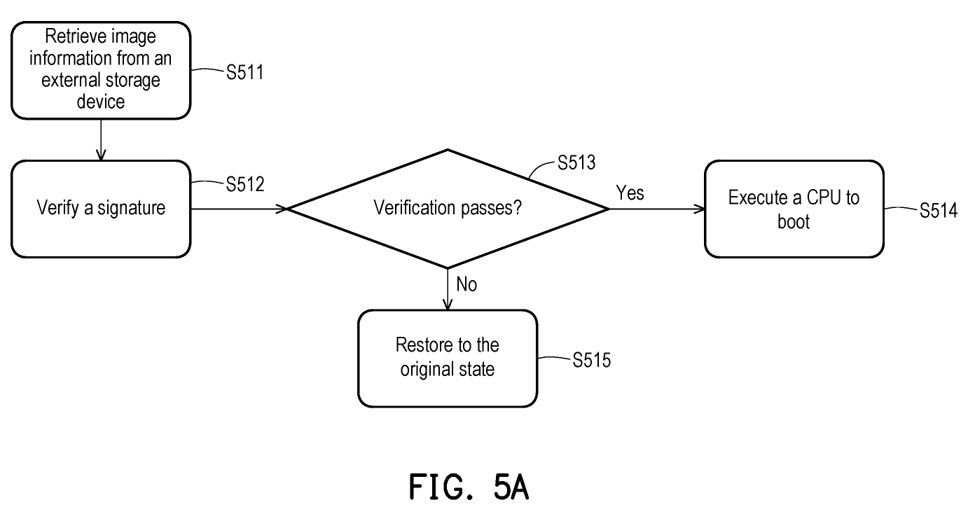

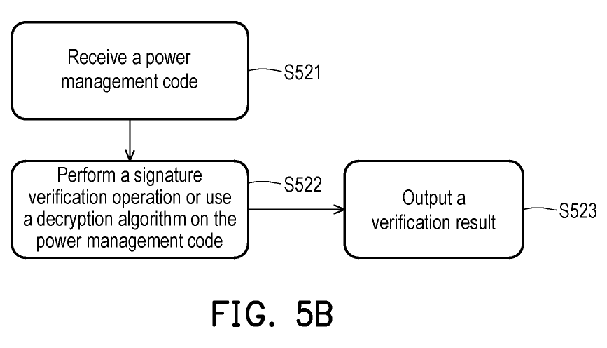

Regarding the operation details of the security check circuit 421, please refer to FIG. 4, FIG. 5A, and FIG. 5B together. FIG. 5A and FIG. 5B respectively illustrate flowcharts of a security check operation of a security check circuit according to an embodiment of the disclosure. First, referring to FIG. 5A, in step S511, the security check circuit 421 may extract image information from an external storage device (such as the memory 410). Afterwards, in step S512, the security check circuit 421 may perform a digital signature verification operation based on the extracted image information. In step S513, the security check circuit 421 may determine whether the digital signature verification operation passes, and step S514 is executed when the digital signature verification operation passes, but step S515 is executed when the digital signature verification operation does not pass.

In step S514, when the digital signature verification operation passes, the electronic device 400 may enable a CPU in the management control circuit 420 to perform the boot operation according to the read boot code BTC. Conversely, in step S515, when the digital signature verification operation does not pass, the management control circuit 420 is restored to the original state.

Next, please refer to FIG. 5B. In step S521, the security check circuit 421 may receive the power management code PMC, and in step S522, the signature verification operation is performed on the power management code PMC, or a decryption algorithm is used on the power management code PMC. Thereby, the security verification operation is performed on the power management code PMC. In step S523, the security check circuit 421 may output a verification result generated in step S522.

In the embodiment of the disclosure, when the verification result indicates that the power management code PMC is secure, the power controller 431 may generate the power control signals PC1 to PCN according to the power management code PMC. Conversely, when the verification result indicates that the power management code PMC is secure, the management control circuit 420 may mask the power management code PMC, which avoids a situation where the power controller 431 executes incorrect code and generates erroneous operation.

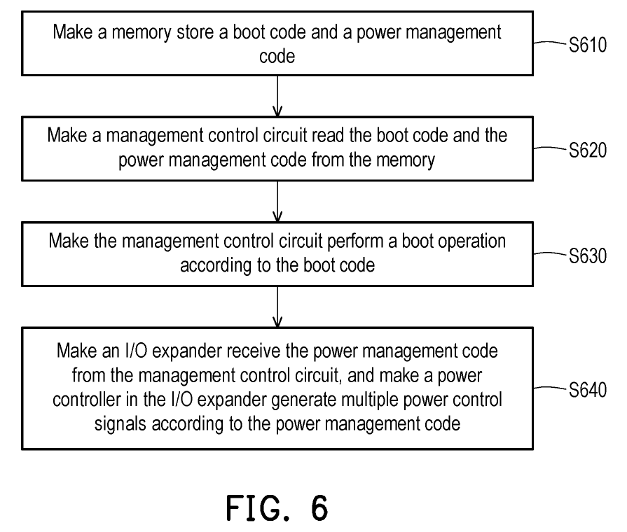

Referring to FIG. 6, FIG. 6 illustrates a flowchart of an operation of an electronic device according to an embodiment of the disclosure. In step S610, the memory stores the boot code BTC and power management code PMC. In step S620, the management control circuit reads the boot code BTC and the power management code PMC from the memory. In step S630, the management control circuit performs the boot operation according to the boot code BTC. Moreover, in step S640, the input/output expander receives the power management code PMC from the management control circuit, and the power controller of the input/output expander generates the power control signals according to the power management code PMC.

Regarding the implementation details of the aforementioned steps, detailed illustrations have already been provided in the aforementioned embodiments, and are not repeated here.

In summary, the electronic device of the disclosure provides the power management code from the management control circuit to the input/output expander, so that the input/output expander may generate the power control signals according to the power management code. As a result, the electronic device does not need to dispose the memory corresponding to the input/output expander, which may effectively reduce the memory usage in the electronic device, reduce the circuit complexity of the input/output expander, lower the design cost required for the electronic device, and enhance the product competitiveness.

What is claimed is:

1. An electronic device, comprising:
a memory, configured to store a boot code and a power management code;
a management control circuit, coupled to the memory, reading the boot code and the power management code from the memory, and performing a boot operation according to the boot code; and
an input/output expander, coupled to the management control circuit, and receiving the power management code from the management control circuit, wherein the input/output expander comprises a power controller, and the power controller generates a plurality of power control signals according to the power management code.

2. The electronic device according to claim 1, wherein the management control circuit comprises a first interface circuit, the input/output expander further comprises a second interface circuit, and the management control circuit performs a data transmission operation through the first interface circuit and the second interface circuit of the input/output expander.

3. The electronic device according to claim 2, wherein the first interface circuit and the second interface circuit are configured to transceive transceived data in a low voltage differential signal format.

4. The electronic device according to claim 2, wherein the management control circuit comprises:
at least one signal format conversion circuit, coupled to the first interface circuit, and configured to perform a format conversion operation on transceived data.

5. The electronic device according to claim 4, wherein the at least one signal format conversion circuit is configured to convert transmitted data to a low voltage differential signal format, and convert received data to an advanced high-performance bus signal format or an instrument bus signal format.

6. The electronic device according to claim 2, wherein the input/output expander comprises:
at least one signal format conversion circuit, coupled to the second interface circuit, and configured to perform a format conversion operation on transceived data.

7. The electronic device according to claim 6, wherein the power controller is coupled to the at least one signal format conversion circuit through a bus, receives the power management code through the bus and the at least one signal format conversion circuit, and generates the plurality of power control signals according to the power management code.

8. The electronic device according to claim 6, wherein the input/output expander further comprises:
a plurality of peripheral circuit controllers, coupled to the at least one signal format conversion circuit, and performing a data transmission operation with the management control circuit through the at least one signal format conversion circuit, the second interface circuit, and the first interface circuit.

9. The electronic device according to claim 1, wherein the management control circuit comprises:
a security check circuit, coupled to a path between the management control circuit receiving the boot code and the power management code, and configured to perform a security verification operation on the boot code and the power management code.

10. The electronic device according to claim 9, wherein the security check circuit performs a signature verification operation on the memory to determine whether to make the management control circuit perform the boot operation according to the boot code.

11. The electronic device according to claim 9, wherein the security check circuit performs a signature verification operation or uses a decryption algorithm on the power management code to confirm whether the power management code is valid or not.

12. The electronic device according to claim 1, wherein after power-on, the management control circuit reads the boot code from the memory, and starts a boot program to perform the boot operation, and the management control circuit reads the power management code from the memory, and sends the power management code to the power controller of the input/output expander.

13. The electronic device according to claim 1, wherein the management control circuit is a baseboard management control circuit.

14. An operation method of an electronic device, comprising:
making a memory store a boot code and a power management code;
making a management control circuit read the boot code and the power management code from the memory;
making the management control circuit perform a boot operation according to the boot code; and
making an input/output expander receive the power management code from the management control circuit, and making a power controller of the input/output expander generate a plurality of power control signals according to the power management code.

15. The operation method of an electronic device according to claim 14, further comprising:
making a first interface circuit of the management control circuit and a second interface circuit of the input/output expander couple with each other to perform a data transmission operation.

16. The operation method of an electronic device according to claim 15, wherein the first interface circuit and the second interface circuit are configured to transceive transceived data in a low voltage differential signal format.

17. The operation method of an electronic device according to claim 14, further comprising:
disposing a security check circuit to perform a security verification operation on the boot code and the power management code.

18. The operation method of an electronic device according to claim 17, further comprising:
making the security check circuit perform a signature verification operation on the boot code to determine whether to make the management control circuit perform the boot operation according to the boot code.

19. The operation method of an electronic device according to claim 17, further comprising:
making the security check circuit perform a signature verification operation or use a decryption algorithm on the power management code to confirm whether the power management code is valid or not.

20. The operation method of an electronic device according to claim 14, further comprising:
after power-on, making the management control circuit read the boot code from the memory, and start a boot program to perform the boot operation; and
making the management control circuit read the power management code from the memory, and send the power management code to the power controller of the input/output expander.
